(19) United States
(12) Patent Application Publication
(10) Pub. No.: US 2025/0040592 A1
(43) Pub. Date: Feb. 6, 2025

(54) ECO-FRIENDLY FILTER WITH BIODEGRADABILITY

(71) Applicants: KT&G CORPORATION, Daejeon (KR); KOLON INDUSTRIES, INC., Seoul (KR)

(72) Inventors: Sung Hoon HA, Daejeon (KR); Jin Chul YANG, Daejeon (KR); Kyeng Bae MA, Daejeon (KR); Bong Su CHEONG, Daejeon (KR); Seung Dong SEO, Gumi-si (KR); Jeong Hun LEE, Gumi-si (KR); Jong Cheol JEONG, Gumi-si (KR); Sang Woo JIN, Gumi-si (KR); Yeong Nam HWANG, Gumi-si (KR)

(73) Assignees: KT&G CORPORATION, Daejeon (KR); KOLON INDUSTRIES, INC., Seoul (KR)

(21) Appl. No.: 18/714,720

(22) PCT Filed: Jun. 7, 2023
(86) PCT No.: PCT/KR2023/007722

§ 371 Date: May 30, 2024

(30) Foreign Application Priority Data
Jul. 28, 2022 (KR) 10-2022-0093836

(51) Int. Cl. A24D 3/06; A24D 1/00; A24D 1/04; A24D 1/20; A24D 3/10; A24D 3/14; A24D 3/16; A24D 3/17

(52) U.S. Cl. CPC A24D 3/068; A24D 1/002; A24D 1/045; A24D 1/20; A24D 3/061; A24D 3/10; A24D 3/14; A24D 3/16; A24D 3/17

(57) ABSTRACT

The present disclosure provides a smoking article filter which includes lyocell tow including lyocell fibers, a binder solution, and filter wrapping paper, and has 90% or higher biodegradation within 6 months according to the American Society for Testing and Materials (ASTM) D6691 under marine conditions at 30° C., and a smoking article including the smoking article filter.

### TECHNICAL FIELD

The present disclosure relates to an eco-friendly filter with biodegradability and a smoking article to which the eco-friendly filter is applied.

### BACKGROUND ART

Cellulose acetate (CA) tow is a chemically modified material made by reacting sulfuric acid and acetic acid with cellulose. In the CA tow used in manufacturing conventional cigarette filters, a plasticizer is applied to improve filter hardness, and in a case in which a filter is manufactured using the CA tow, not only the hardness is improved, but also a binding force between fibers of the CA tow is enhanced. However, a CA filter manufactured using a plasticizer has a problem that it is difficult to meet analysis passing criteria such as marine conditions.

Meanwhile, lyocell tow (L-tow) is a material in the form of a fiber bundle obtained by melting cellulose in an eco-friendly solvent named N-Methylmorpholine N-Oxide (NMMO), instead of modifying the structure of cellulose through a chemical reaction as in the CA tow. The L-tow is an eco-friendly material containing cellulose as its main component, and a binder used to improve hardness of a filter manufactured using the L-tow and a binding force between fibers of the L-tow also corresponds to an eco-friendly material.

### DISCLOSURE

### Technical Problem

In order to overcome the problems and/or limitations of the related art, the present disclosure is directed to providing an eco-friendly lyocell filter with biodegradability, which includes lyocell tow, a binder solution, and filter wrapping paper, and a smoking article including the same.

However, objectives to be achieved by the present disclosure are not limited to that mentioned above, and other unmentioned objectives should be clearly understood by those of ordinary skill in the art from the description below.

### Technical Solution

One embodiment of the present disclosure provides a smoking article filter including lyocell tow including lyocell fibers, a binder solution, and filter wrapping paper, and having 90% or higher biodegradation within 6 months according to the American Society for Testing and Materials (ASTM) D6691 under marine conditions at 30° C.

Another aspect of the present disclosure provides a smoking article including a tobacco medium portion, a filter portion, and a wrapper,

wherein the filter portion includes lyocell tow including lyocell fibers, a binder solution, and filter wrapping paper, and has 90% or higher biodegradation within 6 months according to ASTM D6691 under marine conditions at 30° C.,

a binder in the binder solution is one or more selected from the group consisting of a cellulose-based binder, a vinyl-based binder, and a polyester-based binder, and

the binder solution includes a solvent which is one or more selected from the group consisting of water, ethanol, propylene glycol, and glycerin.

### Advantageous Effects

According to one aspect of the present disclosure, since lyocell fibers having a cellulose network structure are formed into tow to form a filter rod, and the filter rod is applied to a cigarette filter using an eco-friendly binder solution, hardness of the filter can be improved, and an eco-friendly filter with biodegradability can be provided.

Advantageous effects of the present disclosure are not limited to those mentioned above and should be understood as including all advantageous effects inferable from the detailed description of the present disclosure or the configuration of the disclosure stated in the claims.

### DESCRIPTION OF DRAWINGS

FIG. 1 is a view illustrating a schematic configuration of a smoking article according to one embodiment of the present disclosure.

FIG. 2 is a view illustrating a schematic configuration of a smoking article including a wrapper according to one embodiment of the present disclosure.

FIG. 3 is a graph showing biodegradation over time of cellulose, a lyocell filter, lyocell tow, and a cellulose acetate filter under marine conditions for 28 days.

FIG. 4 is a graph showing biodegradation over time of cellulose, a lyocell filter, lyocell tow, and a cellulose acetate filter under marine conditions for 182 days.

### MODES OF THE INVENTION

Hereinafter, embodiments will be described in detail with reference to the accompanying drawings. However, various changes may be made to the embodiments, and thus, the scope of rights of the application is not limited or restricted by the embodiments. All changes, equivalents, or substitutes relating to the embodiments should be understood as belonging to the scope of rights of the application.

Terms used in the embodiments are used for description purposes only and should not be construed as limiting. A singular expression includes a plural expression unless the context clearly indicates otherwise. In the application, terms such as “include” or “have” should be understood as indicating the presence of features, numbers, steps, operations, elements, parts, or combinations thereof and not excluding the possibility of the presence or addition of one or more other features, numbers, steps, operations, elements, parts, or combinations thereof in advance.

Unless otherwise defined, all terms including technical or scientific terms used herein have the same meaning as commonly understood by one of ordinary skill in the art to which the embodiments pertain. Terms, such as those defined in commonly used dictionaries, should be construed as having a meaning that is consistent with their meaning in the context of the relevant art and are not to be construed in an idealized or overly formal sense unless expressly so defined herein.

Also, in giving descriptions with reference to the accompanying drawings, the same reference numerals are assigned to the same components wherever possible even when the components are illustrated in different drawings, and repeated description thereof will be omitted. In describing the embodiments, when detailed description of a known related art is determined as having the possibility of unnecessarily obscuring the gist of the embodiments, the detailed description thereof will be omitted.

Also, in describing components of the embodiments, terms such as first, second, A, B, (a), and (b) may be used. Such terms are only for distinguishing one component from another component, and the essence, order, sequence, or the like of the corresponding component is not limited by the terms.

A component including a common function with a component included in any one embodiment will be described using the same name in another embodiment. Unless the context clearly indicates otherwise, description made in any one embodiment may apply to another embodiment, and detailed description will be omitted in a repeated range.

In this specification, a “smoking article” may refer to anything capable of generating an aerosol, such as tobacco (cigarette) and cigars. The smoking article may include an aerosol-generating material or an aerosol-forming substrate. Also, the smoking article may include a solid material based on tobacco raw materials, such as reconstituted tobacco leaves, cut tobacco leaves, and reconstituted tobacco. A smoking material may include a volatile compound.

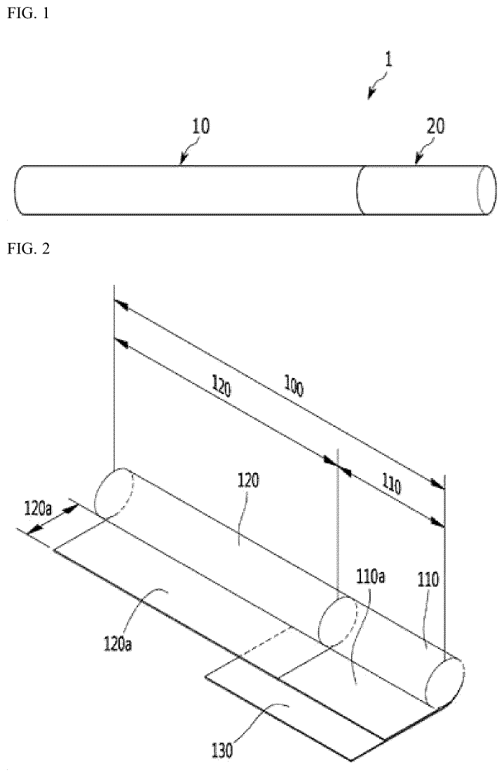

Also, in this specification, “upstream” or “upstream direction” refers to a direction moving away from an oral region of a user smoking a smoking article 1, and “downstream” or “downstream direction” refers to a direction approaching the oral region of the user smoking the smoking article 1. For example, in the smoking article 1 illustrated in FIG. 1, a tobacco medium portion 10 is disposed upstream or in an upstream direction of a cigarette filter portion 20.

Further, in the specification, although a case in which the smoking article 1 is a combustion-type cigarette is described as an example, the present disclosure is not limited thereto, and the smoking article 1 may also correspond to a heating-type cigarette used along with an aerosol generation device (not illustrated), such as an electronic cigarette device.

One embodiment of the present disclosure provides a smoking article filter including lyocell tow including lyocell fibers, a binder solution, and filter wrapping paper and having 90% or higher biodegradation within 6 months according to the American Society for Testing and Materials (ASTM) D6691 under marine conditions at 30° C.

The lyocell tow including the lyocell fibers contains cellulose as its main component and corresponds to an eco-friendly material. The lyocell tow including the lyocell fibers may have 15 to 60 crimps (pleats) per inch and may have a whiteness of 80 to 95%.

In a case in which the number of crimps exceeds the above range, a strength of the lyocell tow weakens. Conversely, in a case in which the number of crimps of the lyocell tow is less than the above range, filling power of the tow is reduced, and a problem occurs that it is difficult to implement appropriate resistance to draw compared to weight.

In a case in which the whiteness is less than 80%, color of the filter becomes yellowish, greyish, or the like, and in this case, the color may cause the smoker to have a negative perception that the filter is not clean. Also, a whiteness higher than 95% is technically difficult to implement and, even when implemented, causes a problem of a cost increase.

Meanwhile, in order to improve the hardness of the manufactured lyocell filter and enhance the binding force between the fibers of the tow, a binder solution may be included when manufacturing the filter. A binder used in the binder solution is also made of an eco-friendly material, and a solvent used to dissolve the binder is also an eco-friendly solvent. As a specific example, the binder may be one or more selected from the group consisting of a cellulose-based binder, a vinyl-based binder, and a polyester-based binder.

More specifically, examples of the cellulose-based binder may include hydroxypropyl methylcellulose (HPMC), ethyl cellulose (EC), methyl cellulose (MC), carboxymethyl cellulose (CMC), and the like, and examples of the vinyl-based binder may include polyvinylpyrrolidone (PVP), polyvinyl alcohol (PVA), ethylene vinyl acetate (EVAc), and the like. Further, the polyester-based binder may be polyester including one or more selected from the group consisting of C5-C12 alkylene, C5-C12 arylene, and C5-C12 hetero-arylene.

Meanwhile, as described in the following embodiments and the like, it may be preferable to use the polyester-based binder in that the polyester-based binder can more effectively prevent the hardness of the filter from being reduced due to the smoker's saliva or the like during smoking.

Specific examples of the eco-friendly solvent for dissolving the binder may include water, ethanol, propylene glycol (PG), glycerin, and the like. More specifically, the eco-friendly solvent may be PG.

In a case in which PG is used as the solvent for dissolving the binder, since PG serves as a release agent, and thus a phenomenon in which the lyocell tow is adhered and stuck between rolls of filter equipment is reduced, efficiency of the filter manufacturing process is increased, and it is possible to prevent and overcome a phenomenon in which strength of a filter made of a cellulose-based material is weakened that occurs in a case in which a polar solvent such as water is used.

Meanwhile, the filter wrapping paper included in the lyocell filter may correspond to porous paper, nonporous paper, or the like that may surround the lyocell tow to which the binder is applied and maintain a cylindrical shape of the filter. Also, the filter wrapping paper may be manufactured using flax, wood pulp, or the like, and combustibility and a taste of tobacco are required to be maintained during burning of the filter wrapping paper. Further, the filter wrapping paper may include a filler, and accordingly, opacity of the filter wrapping paper can be increased, porosity can be imparted to the filter wrapping paper, and smoothness and ash integrity of the filter wrapping paper can be improved. Examples of the filler include materials such as calcium carbonate, titanium dioxide, and magnesium oxide.

Still another embodiment of the present disclosure may provide a smoking article including a tobacco medium portion, a filter portion, and a wrapper,

wherein the filter portion includes lyocell tow including lyocell fibers, a binder solution, and filter wrapping paper and has 90% or higher biodegradation within 6 months according to ASTM D6691 under marine conditions at 30° C.,

a binder in the binder solution is one or more selected from the group consisting of a cellulose-based binder, a vinyl-based binder, and a polyester-based binder, and

the binder solution includes a solvent which is one or more selected from the group consisting of water, ethanol, propylene glycol, and glycerin.

The filter portion included in the smoking article may be viewed as substantially similar to the lyocell filter described above, and specific components included in the filter portion are as described above.

Also, the filter portion of the smoking article may be divided into two or more segments such as a first segment, a second segment, and the like. As long as one of the two or more segments corresponds to the filter according to one embodiment of the present disclosure including the lyocell tow and the binder solution, regardless of where the one segment is disposed, the filter portion may be included within the scope of the present disclosure. Further, one or more of the two or more segments may include a capsule capable of generating a flavor, and the shape of the capsule may correspond to a spherical shape, a cylindrical shape, or the like but is not limited thereto.

Further, the tobacco medium portion may generally include a tobacco material including nicotine such as tobacco leaves and may further include an excipient such as a binder or other additives. As an example, a tobacco medium included in the tobacco medium portion of the present disclosure may be produced in the form of granules including the tobacco material, the excipient, and the like. Also, a flavoring liquid such as menthol or a moisturizer may be dispersed in the tobacco medium in order to be added to the tobacco medium portion.

In the present disclosure, the tobacco material is a material forming an aerosol-generating substrate and may be pieces of tobacco leaves, tobacco stems, tobacco powder generated while processing tobacco, and/or strips of tobacco leaves. The tobacco leaves may be at least one or more selected from bright tobacco leaves, burley tobacco leaves, oriental tobacco leaves, cigar tobacco leaves, and toasted tobacco leaves, but the present disclosure is not limited thereto.

Meanwhile, as illustrated in FIG. 2, the wrapper according to one embodiment of the present disclosure may include a wrapper for each component of the smoking article and may be divided into a tobacco medium portion wrapper 110a configured to wrap around the tobacco medium portion, a filter portion wrapper (filter wrapping paper) 120a configured to wrap around the filter, and the like. Further, in the case in which the filter portion is divided into a plurality of segments as described above, the wrapper according to one embodiment of the present disclosure may include a wrapper for each segment that is configured to wrap around the segment. Also, the smoking article may include a tipping wrapper 130 configured to wrap around a partial area of the tobacco medium portion and the filter portion in order to fix the connection between the tobacco medium portion and the filter portion and may also include an outer wrapper positioned at the outermost portion of the smoking article while wrapping around all of the tobacco medium portion, the filter portion, and the like in order to maintain the overall shape of the smoking article.

One or more perforations may be selectively formed in a circumferential direction in the tipping wrapper configured to combine the tobacco medium portion and the filter in order to allow outside air to enter or an internal gas to exit. In this way, there are advantageous effects that an air dilution rate of a cigarette can be increased, and the amount of delivered mainstream smoke components can be controlled.

Hereinafter, the configurations of the present disclosure and the advantageous effects according thereto will be described in more detail using examples and comparative examples. However, the examples are merely for describing the present disclosure in more detail, and the scope of the present disclosure is not limited by the examples.

### Examples

### (1) Experiment for Evaluating Biodegradation Under Marine Conditions

Analysis samples ground to a size of 1 mm or less and a control sample, which is standard cellulose powder, were used to conduct an experiment (for 28 days and 182 days) under marine conditions at 30° C.

In order to evaluate biodegradation, the amount of carbon dioxide generated due to decomposition of the samples and the amount of carbon dioxide generated due to decomposition of the standard product were measured, and the amount of carbon dioxide measured in the analysis samples and the amount of carbon dioxide generated due to decomposition of the standard product were compared to calculate relative biodegradation.

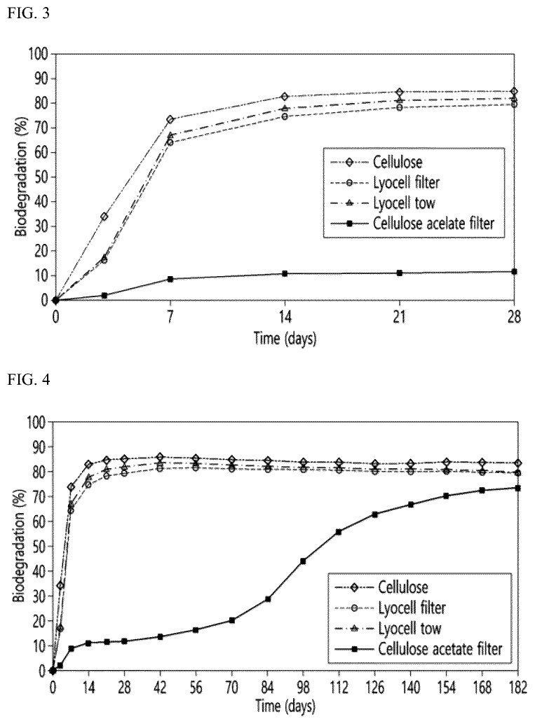

As a result, as shown in Table 1 and FIG. 3 (which correspond to the experiment for 28 days) and Table 2 and FIG. 4 (which correspond to the experiment for 182 days), the lyocell filter according to one embodiment of the present disclosure was confirmed as having 90% or higher biodegradation relative to the standard product under marine conditions not only within 6 months but also in a short period of 28 days.

TABLE 1

| | TOC | Net CO₂ | Biodegradation(%) | | |
|---|---|---|---|---|---|
| Test series | (%) | (mg) | AVG | SD | REL |
| Cellulose | 42.7 | 79.6 | 84.7 | 1.2 | 100.0 |
| Lyocell | 42.0 | 73.5 | 79.5 | 1.9 | 93.9 |
| Filter | | | | | |
| Lyocell | 41.5 | 74.9 | 82.0 | 1.1 | 96.8 |
| Tow | | | | | |
| Cellulose | 47.5 | 12.1 | 11.6 | 0.9 | 13.7 |
| Acetate | | | | | |
| Filter | | | | | |

(Result of evaluating biodegradation under marine conditions for 28 days)

TABLE 2

| | TOC | Net CO₂ | Biodegradation(%) | | |
|---|---|---|---|---|---|
| Test series | (%) | (mg) | AVG | SD | REL |
| Cellulose | 42.7 | 78.1 | 83.1 | 3.2 | 100.0 |
| Lyocell | 42.0 | 73.4 | 79.4 | 3.4 | 95.5 |
| Filter | | | | | |
| Lyocell | 41.5 | 73.0 | 79.9 | 1.1 | 96.1 |
| Tow | | | | | |
| Cellulose | 47.5 | 76.8 | 73.5 | 3.9 | 88.4 |
| Acetate | | | | | |
| Filter | | | | | |

(Result of evaluating biodegradation under marine conditions for 182 days)
* AVG = Average
* SD = Standard deviation
* REL = Relative biodegradation

### (2) Experiment for Degree of Collapse Due to Moisture

A phenomenon in which the hardness of the filter is reduced due to the smoker's saliva or the like during smoking was simulated to measure the degree of collapse due to moisture of the filter according to the presence/absence of the binder and the type of binder.

Specifically, Filtrona's DHT 200™ was used to measure the hardness of the filter before and after adding water thereto, and 20 μl of water was added to the filter. The amount of added water was set by, after a group of smokers smoked a cigarette equipped with the lyocell filter, measuring a value of moisture remaining in the filter.

A difference between the hardness before adding water and the hardness after adding water was divided by the initial hardness to determine the degree of collapse, the result of which is shown below.

$$Hardness ( \% ) = ( filter diameter ( mm ) - length ( mm ) by which the filter is compressed when pressed by a 300 - g weight ) / initial filter diameter ( mm ) \times 100$$

$$Degree of collapse due to moisture ( \% ) = ( filter hardness before adding water - filter hardness after adding water ) / ( filter hardness before adding water ) \times 100$$

TABLE 3

| | Hardness (%) | | |
|---|---|---|---|
| | Before adding | | Degree of collapse |
| Sample | water | After adding water | due to moisture |
| Blank | 84.7 | 77.4 | 8.6 |
| PVP | 94.3 | 84.9 | 10.0 |
| Polyester | 91.5 | 86.1 | 5.9 |

* Blank = sample to which binder was not added

A polyvinylpyrrolidone (PVP) binder has a characteristic of easily breaking down in water due to a resonance structure of an amide group in the structure thereof, and as shown in Table 3 above, the PVP binder was confirmed as having a degree of collapse due to moisture of 10.0%. In the case of the polyester-based binder, although the polyester-based binder is melted or dispersed in water initially, since the polyester-based binder has a characteristic of not easily breaking down in water after an adhesive strength of the binder is imparted, the degree of collapse due to moisture was measured to be 5.9%, which is low.

From such results, it can be seen that, in the case in which the polyester-based binder is used as the binder, the degree of collapse due to moisture is further lowered, thus having an effect of preventing the hardness of the filter from being reduced due to the smoker's saliva or the like during smoking, compared to cases in which a binder is not used or other types of binders are used.

The embodiments have been described above using only some drawings, but those of ordinary skill in the art may apply various technical modifications and changes based on the above. For example, appropriate results may be achieved even when operations described herein are performed in a different order from the method described herein, and/or components such as a system, a structure, a device, and a circuit described herein are coupled or combined in different forms from the method described herein or replaced or substituted with other components or their equivalents.

Therefore, other implementations, other embodiments, and those equivalent to the claims below fall within the scope of the claims.

1. A smoking article filter comprising:
lyocell tow including lyocell fibers;
a binder solution; and
filter wrapping paper,
wherein biodegradation of the smoking article filter within 6 months according to the American Society for Testing and Materials (ASTM) D6691 is 90% or higher under marine conditions at 30° C.

2. The smoking article filter of claim 1, wherein:
a degree of collapse of the smoking article filter due to moisture of the smoking article filter is 7% or lower; and
the degree of collapse due to moisture is defined by the equation below.
$$Degree of collapse due to moisture ( \% ) = ( filter hardness before adding water - filter hardness after adding water ) / ( filter hardness before adding water ) \times 100$$

3. The smoking article filter of claim 1, wherein the lyocell tow has 15 to 60 crimps per inch.

4. The smoking article filter of claim 1, wherein the lyocell tow has a whiteness of 80 to 95%.

5. The smoking article filter of claim 1, wherein the binder is one or more selected from the group consisting of a cellulose-based binder, a vinyl-based binder, and a polyester-based binder.

6. The smoking article filter of claim 5, wherein:
the cellulose-based binder is one or more selected from the group consisting of hydroxypropyl methylcellulose (HPMC), ethyl cellulose (EC), methyl cellulose (MC), and carboxymethyl cellulose (CMC);
the vinyl-based binder is one or more selected from the group consisting of polyvinylpyrrolidone (PVP), polyvinyl alcohol (PVA), polyvinyl acetate (PVAc), and ethylene vinyl acetate (EVAc); and
the polyester-based binder includes one or more selected from the group consisting of C5-C12 alkylene, C5-C12 arylene, and C5-C12 hetero-arylene.

7. The smoking article filter of claim 1, wherein a binder in the binder solution is the polyester-based binder including one or more selected from the group consisting of C5-C12 alkylene, C5-C12 arylene, and C5-C12 hetero-arylene.

8. The smoking article filter of claim 1, wherein the binder solution includes a solvent which is one or more selected from the group consisting of water, ethanol, propylene glycol, and glycerin.

9. The smoking article filter of claim 8, wherein the solvent is one or more of propylene glycol and glycerin.

10. The smoking article filter of claim 1, wherein the filter wrapping paper is manufactured using flax or wood pulp and includes a filler which is one or more selected from the group consisting of calcium carbonate, titanium dioxide, and magnesium oxide.

11. A smoking article comprising:
a tobacco medium portion;
a filter portion; and
a wrapper,
wherein the filter portion includes lyocell tow including lyocell fibers, a binder solution, and filter wrapping paper, and has 90% or higher biodegradation within 6 months according to ASTM D6691 under marine conditions at 30° C.,
a binder in the binder solution is one or more selected from the group consisting of a cellulose-based binder, a vinyl-based binder, and a polyester-based binder, and
the binder solution includes a solvent which is one or more selected from the group consisting of water, ethanol, propylene glycol, and glycerin.

12. The smoking article of claim 11, wherein:
the cellulose-based binder is one or more selected from the group consisting of hydroxypropyl methylcellulose (HPMC), ethyl cellulose (EC), methyl cellulose (MC), and carboxymethyl cellulose (CMC);
the vinyl-based binder is one or more selected from the group consisting of polyvinylpyrrolidone (PVP), polyvinyl alcohol (PVA), and ethylene vinyl acetate (EVAc); and
the polyester-based binder includes one or more selected from the group consisting of C5-C12 alkylene, C5-C12 arylene, and C5-C12 hetero-arylene.

13. The smoking article of claim 11, wherein the solvent is one or more of propylene glycol and glycerin.

14. The smoking article of claim 11, wherein the filter portion further includes a capsule capable of generating a flavor.

15. The smoking article of claim 11, wherein a flavoring liquid is added to the tobacco medium portion.
